(19) United States
(12) Patent Application Publication
(10) Pub. No.: US 2008/0242157 A1
(43) Pub. Date: Oct. 2, 2008

(54) NON-CONDUCTIVE COATING FOR LIGHTING DEVICES

(76) Inventor: Eric V. Farone, Boston Heights, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/691,230

(22) Filed: Mar. 26, 2007

(51) Int. Cl. H01R 24/10

(52) U.S. Cl. 439/699.2

(57) ABSTRACT

A device and method are disclosed that facilitate removal of an electric lamp, such as a light bulb, from a socket. A thin layer of electrically non-conductive material is applied to the contact surface of the lamp and/or the socket prior to the lamp being inserted into the socket.

### FIELD OF THE INVENTION

The present invention is directed to an apparatus and a method of providing a non-conductive coating to lighting devices. In particular, the present invention is directed to providing a non-conductive coating to a conductive screw base of a lamp and/or a lamp socket for facilitating engagement with and removal of the lamp from the lamp socket.

### BACKGROUND OF THE INVENTION

A commonly encountered problem associated with the installation and removal of lamps from sockets is the difficulty in removing the lamp from the socket, especially after a period of time, and sometimes the difficulty in properly inserting a lamp into a socket so that it makes proper electrical contact. The problem is exacerbated where the lamp fixture containing the lamp is exposed to moisture that may induce corrosion between the metallic threads of the lamp and the metallic threads of the socket. This problem becomes especially acute since it the common practice to grasp the glass portion of the lamp in the hand while attempting to either place it in or remove the lamp from the socket. When resistance is encountered, it is common for the lamp to separate from the lamp threads. This typically results in the individual holding lamp portion in his or her hand and the threaded portion of the lamp remaining engaged in the socket.

There are several possible explanations for why the aforementioned difficulties in placing and removing electric lamps from sockets are encountered. First, it is clear that the engagement between the contact surface of the base of the lamp and the interior contact surface of the socket must be fairly close to insure proper electrical contact and transmission. Thus, a tight fit is required. For lamps having a screw-type engagement, the threads of the screw are stamped or roll formed from relatively thin sheet metal and, as a result, the threads of the lamp and the socket may not match exactly. Additionally, the respective contact surfaces are usually both metal, and the metal surfaces have a relatively high co-efficient of friction, especially in the circumstance of a rather tight engagement, which leads to binding. In addition, when a lamp has been in use in a particular socket over an extended period of time, especially in a damp environment, some corrosion occurs between the metallic surfaces as a consequence of the transmission of electrical energy between these surfaces and this can exacerbate the problems heretofore described.

Thus, it would be desirable to provide an improved lamp base and/or socket for lamps that facilitate the installation and removal of the lamp from the socket in which it is positioned to receive electric energy.

### SUMMARY OF THE INVENTION

Accordingly, the present invention is directed to a device and method which substantially obviates the aforementioned problems and disadvantages by significantly facilitating the ease by which electric light bulbs can be installed in or removed from sockets or contact receptacles.

An aspect of the present invention relates to a lamp comprising: a bulb; a base member secured to the bulb, wherein the base member includes an electrically conductive contact surface for engaging with an associated socket, wherein the electrically conductive contact surface includes an outer layer of electrically non-conductive lubricant material for facilitating removable engagement of said base member with the associated socket.

Another aspect of the present invention relates to an incandescent electric lamp comprising a bulb with an electrically conductive cylindrical base member attached thereto; said base member having an electrical contact surface with male threads disposed thereon for engaging with female threads disposed in a socket of a source of electric energy for said light, said threaded contact surface being provided with a layer of an electrically non-conductive material to facilitate removable engagement of said base number with said socket.

Another aspect of the present invention relates to a compact fluorescent lamp comprising a bulb with an electrically conductive cylindrical base member attached thereto; said base member having an electrical contact surface with male threads disposed thereon for engaging with female threads disposed in a socket of a source of electric energy for said light, said threaded contact surface being provided with a layer of an electrically non-conductive material to facilitate removable engagement of said base number with said socket.

Another aspect of the present invention relates to a socket comprising: a threaded conductive sleeve for receiving an associated lamp having a threaded base, wherein the socket includes an electrically conductive contact surface for engaging the associated lamp, wherein the electrically conductive contact surface includes an outer layer of electrically non-conductive lubricant material for facilitating removable engagement of said associated lamp with the threaded conductive sleeve.

Another aspect of the present invention relates to a method of facilitating placement and removal of a base of an electric light bulb from a socket for providing electric energy to said light bulb which comprises applying an electrically non-conductive lubricant material to the portion of said base which contacts said 10 socket prior to inserting said base into said socket.

Another aspect of the present invention relates to a method of facilitating placement and removal of a base of an electric light bulb from a socket for providing electric energy to the light bulb which comprises applying an electrically non-conductive lubricant material to a portion of the socket base that contacts the base of the light bulb prior to inserting said base into said socket.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is cross-sectional view of a lamp in accordance with aspects of the present invention.

FIG. 2 is a cross-sectional view of a socket in accordance with aspects of the present invention.

### DETAILED DESCRIPTION

Aspects of the present invention relate to an electric lamp (also referred to herein as a “light bulb”) comprising a bulb with one or more electrically conductive base members attached. The one or more base members generally have electrically conductive contact surfaces. A non-conductive lubricant material coating is provided to facilitate removable engagement of the base members with a socket. As used herein, the term “non-conductive” means that the specified material is not able to conduct electricity in the bulb or lamp rated operating voltage.

In another embodiment, a socket is provided for receiving an associated lamp having a threaded base. The socket includes an electrically conductive contact surface for engaging the associated lamp. The electrically conductive contact surface includes an outer layer of electrically non-conductive lubricant material for facilitating removable engagement of said associated lamp with the threaded conductive sleeve.

In yet another embodiment, the socket and/or threaded based of the lamp may be manufactured from a metal having a non-conductive lubricant embedded in the metal.

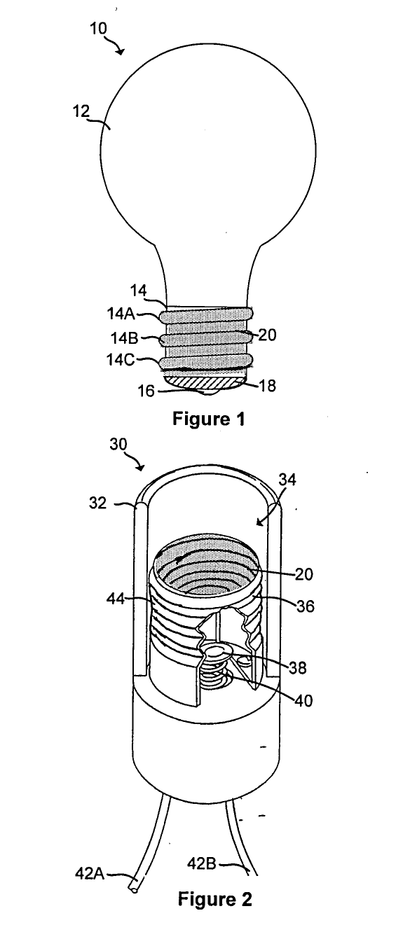

Reference will now be made in detail to the present preferred embodiments of the invention, examples of which are illustrated in the accompanying drawings. An exemplary lamp 10 in accordance with aspects of the present invention is illustrated in FIG. 1. The lamp 10 may be any type of illuminating device, such as an incandescent light bulb, a fluorescent light bulb, a compact fluorescent light bulb, bayonet base bulbs, mercury or sodium vapor lights, etc. The lamp 10 generally includes a bulb 12 having an electrically conductive base member 14 attached thereto. In the illustrated embodiment, the base member 14 has contact surfaces 14A-14C, which are male threads for engaging with female threads on a socket of an electric energy source (shown in FIG. 2). The lamp 10 further includes a button contact 16 for providing electrical contact with a socket. The button contact 16 is insulated from the base member 14 by insulator 18.

A thin layer of non-conductive material 20 is applied to the conductive base member 14 (e.g. contact surfaces 14A-14C) in order to facilitate installation and removal of the base member 14 from a socket. The non-conductive material 20 is preferably a lubricant that is electrically non-conductive. The non-conductive material 20 may take any form (e.g., a gas, liquid, solid, microspheres, paste, etc.) and may be applied either as a solid, in the form of a paste, as a liquid, or as a spray that adheres to the surface of the base member 14.

Referring to FIG. 2, a socket (or lamp holder) 30 in accordance with aspects of the present invention is illustrated. The socket 30 includes a body 32, a socket cavity 34, a conductive sleeve (e.g., metal) 36, a conductive contact arm 38, an optional coil spring 40 to urge contact between the conductive contact arm 38 and button contact 16, and lead wires 42A and 42B. The socket 30 accepts and provides full electrical connection with the lamp 10. The body 32 of the lamp holder 10 may be manufactured from any insulating material. Exemplary insulating materials generally include: rubber, plastic, porcelain, ceramics and the like. Body 32 is generally cylindrical and includes a cavity that forms at least a part of the socket 30. The socket cavity 34 generally contains a conductive sleeve 36 that includes formed threads 44. The formed threads 44 are typically complementary to the base member threads 14A-14C of the lamp 10, as illustrated in FIG. 1.

The interior portion of the conductive sleeve (e.g., the portion that engages the conduct base member 14 of the lamp 10) has a thin layer of non-conductive material 20. The non-conductive material 20 is identical to the non-conductive material 20 discussed with respect to the lamp 10. As one of ordinary skill will readily appreciate, the non-conductive material 20 may be applied to the electrical conductive portions of the lamp 10 (e.g., base member 14) and/or the electrical conductive portions of the socket 30 (e.g. conductive sleeve 36). Preferably, the non-conductive material 20 is applied to either the base member 14 or the conductive sleeve 36 before insertion of the lamp 10 into the socket 30. In another embodiment, the non-conductive material 20 may be embedded in the material used to manufacture the base member 14 and/or conductive sleeve 30. In another embodiment, the non-conductive material 20 may also take the form of microspheres. The coating of the microsphere housing may be a non-conductive lubricant material. In another embodiment, the microspheres may be filled with a non-conductive material 20 that releases from the confines of the microspheres during insertion of the base member 14 into a socket, which causes the microsphere housing to fracture and release the non-conductive material 20.

The electrically non-conductive material 20 employed in accordance with aspects of the invention may take various forms and be applied using any of several techniques such as spraying, dipping, applying, painting on with a brush, embedding within the material that forms the socket and/or base member, etc.

A preferred characteristic of the material 20 is that it be electrically non-conductive. As stated above, a thin layer of non-conductive material 20 has been found not to interfere with transmission of electrical energy to the illuminating device and that the material 20 provide sufficient reduction in the coefficient of friction between the base member and the socket to achieve the desired facilitation of installation and removal. Further, the material 20 should not substantially deteriorate over time or as a result of exposure to electrical transmission or have a corrosive effect on the contact surface. Preferably, the material 20 may inhibit corrosion between the contact surfaces of the bulb and the engaging socket.

### EXAMPLES

Several different styles of lamps were installed into sockets, as typically used, both with and without a non-conductive lubricant 20 added either to the base of the light bulb and/or the socket fixture.

The immediate observation was that where a lubricant was added, the lamps turned in the sockets much more easily than the un-lubricated versions, thus allowing much easier installation and less over tightening. All bulbs illuminated properly when the appropriate electricity was applied. The test lights with lubricant were much easier to remove from the sockets when tested within one (1) hour of installation.

The lubricated and non-lubricated lamp installations were then left in place in the appropriate fixtures and used as normal for approximately four months. After using the lamps for this period of time, an attempt to remove each lamp took place. The lamp installations that incorporated a lubricant were decidedly easier to remove and replace than those without the lubricant. Removal of bulbs in which no lubricant was introduced was generally difficult. In one case where a narrow-based chandelier bulb was used, the bulb broke away leaving the threaded base of the bulb stuck in the socket.

Additionally, it was noted that removal and replacement of lamps from recessed ceiling fixtures by use of an extension handle with a suction cup affixed to the end (e.g., a tool designed to reach a light bulb from higher ceiling installations not conveniently reached with a ladder) released readily and was replaced easily. The same application without the lubricant applied to either the lamp and/or the socket required substantially greater pressure. In one instance, a fixture was pushed into the ceiling while trying to achieve enough of a grip on the bulb to allow it to turn.

The types of light bulbs evaluated in the tests included are identified in Table 1 below.

TABLE 1

| | | |
|---|---|---|
| G.E. | 75 watt | standard “soft white” bulb |
| G.E. | 40 watt | appliance bulb |
| G.E. | 45 watt | “soft white” flood light bulb for raised fixtures |
| G.E. | 25 watt | narrow base, clear chandelier bulb-indoor |
| | | application |
| G.E. | 60 watt | narrow base, “soft white”, chandelier bulb- |
| | | outdoor application |
| Generic | 150 watt | indoor/outdoor flood light, indoor application |
| Philips | 60 watt | halogen bulb |
| Feit | 65 watt | compact fluorescent, 15 watt flood light bulb |
| Electric | replacement | |
| Feit | 100 watt | compact fluorescent, 26 watt halogen bulb |
| Electric | replacement | |
| Philips | 100 watt | “natural light” incandescent bulb |
| G.E. | 60 watt | “reveal” incandescent |

Table 2 lists the types of non-conductive material lubricants used in the testing.

TABLE 2

| | |
|---|---|
| A | WD-40 aerosol spray |
| B | Petroleum jelly |
| C | Castrol syntec synthetic motor oil |
| D | Canola oil |
| E | Lube Job, Aerosol Silicones Lubricant by |
| | AVW inc. |
| F | Heavy Duty Silicone, Aerosol Silicone by |
| | CRC Industries |
| G | Super Lube, Dri-Film Lubricant with PTFE, |
| | aerosol by Synca Chemical Corp. |
| H | DuPont Teflon Silicone Lubricant, Aerosol by |
| | DuPont |
| J | No lubricant added |

All of the above listed non-conductive material lubricants had a significant effect of reducing friction and torque required to install or remove light bulbs when applied either to the threads on the base of the light bulb, or to the receiving socket. The aerosols were applied with a light spray, and the others applied sparingly with a cotton swab.

Table 3 summarizes the performance of the non-conductive material lubricants in the various tests. The results are provided on ranking scale of 1-10, with 1 representing the lubricant with the best release properties and 10 the most difficult or breakage.

TABLE 3

| Product | Rating | Comment |
|---|---|---|
| H | 1 | Excellent release, no build- |
| | | up, odor or staining |
| G | 1 | Same as H |
| F, E | 2 | Very good release after use |
| | | maintained lubricity |
| A | 3 | Very good release, some |
| | | initial odor |
| C, D | 5 | Decent release but with slight |
| | | gummy build-up |
| B | 6 | Some release, appeared to |
| | | melt |
| J | 10 | Binding, sticking and/or |
| | | broken bulbs |

The test lamps were left in place, and put through continued normal use for the lamp and application for approximately 9 months or the light bulb burned out. The efficiency of the non-conductive material lubricants essentially followed the ranking set forth in Table 3 above. Products with a rating of 1, 2 or 3 did not leave behind any significant residue. Testing these products was accomplished by applying the lubricant sparingly to the base of the bulb, energizing and allowing an incandescent 75 watt bulb to heat up and stay illuminated for 2 hours, allowed to cool, then replaced with a freshly lubricated bulb. There were no signs of build-up in the socket after 6 cycles. Additionally, it should be noted that at no time did there appear to be a detrimental effect on the electrical integrity of the circuit.

Therefore, it appears almost any non-conductive lubricant may help prevent sticking or binding, and the lubricant can be applied to the bulb and/or the socket. This application may be made by wiping, dipping or any reasonable method of introduction, as explained above. Additionally, the application of the non-conductive lubricant material may be accomplished during the manufacture of the lamps and/or the socket. The non-conductive lubricant material may also be supplied separately for application by the consumer. For example, a separate item to be applied to a wipe or included as a small wipe towelette. Preferably, an economical approach, but by no means an exclusive approach, would be for the lamp manufacturer to apply a non-conductive lubricant during manufacturing or packaging of the lamp. This would provide an opportunity for the lubricant to dry prior to use, which may avoid staining of the packaging. If applied by the socket manufacturer, a more permanent Teflon, silicone or other material may be suitable. An additional benefit to the hydrophobic lubricants is to also reduce corrosion in outdoor applications, heavy duty security and/or site illumination applications, all of which generally have more corrosive environments than household lighting applications.

Weight measurements were done to observe the approximate amount of material (lubricant) that would typically be required for anti-sticking/binding properties. The DuPont Teflon silicone lubricant in aerosol spray can was used as the lubricant. Being aerosol, once applied, it is expected the aerosol solvent carriers will evaporate and leave behind a thin layer of essentially dry lubricant. The weighing test was carried out on an electronic balance accurate to a +0.01 gram. Each lamp was weighed, then sprayed with a light coating of lubricant and immediately re-weighed. After resting for 1 minute, for the volatile solvents to evaporate, the lamp was weighed again to understand how much lubricant remained. A summary is provided in Table 4 below.

TABLE 4

| | | | Dry Weight |
|---|---|---|---|
| Bulb | Tare (g) | Sprayed Weight (g) | (g) |
| G.E. 75 watt bulb | 26.00 | 26.06 | 26.02 |
| G.E. 40 watt appl. | 22.71 | 22.7 | 22.73 |
| Bulb | | | |
| G.E. 45 watt 4″ | 56.87 | 56.92 | 56.89 |
| flood-record type | | | |
| bulb | | | |

Thus, it appears that 0.02 grams of this lubricant is sufficient to create the desired smooth installation and removal of threaded base bulb for residential applications. Larger bulbs for industrial use would be expected to require larger quantities.

Specific embodiments of the invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

What is claimed is:

1. A lamp comprising:
a bulb;
a base member secured to the bulb, wherein the base member includes an electrically conductive contact surface for engaging with an associated socket, wherein the electrically conductive contact surface includes an outer layer of electrically non-conductive lubricant material for facilitating removable engagement of said base member with the associated socket.

2. The lamp of claim 1, wherein the base member is a cylinder and said contact surfaces are male threads disposed thereon for engaging with female threads disposed in the associated socket.

3. The lamp of claim 1, wherein the non-conductive lubricant material is a solid lubricant.

4. The lamp of claim 1, wherein the non-conductive lubricant material is a liquid lubricant.

5. The lamp of claim 1, wherein the non-conductive lubricant material is at least one selected from the group consisting of WD-40 aerosol spray, petroleum jelly, motor oil, canola oil, silicone, dri-film lubricant, Teflon silicone lubricant or aerosol silicones.

6. The lamp of claim 1, wherein the non-conductive lubricant material includes a plurality of microspheres.

7. The lamp of claim 1, wherein the lamp is an incandescent light bulb.

8. The lamp of claim 1, wherein the lamp is a fluorescent light bulb.

9. The lamp of claim 1, wherein the lamp is a compact fluorescent light bulb.

10. The lamp of claim 1, wherein the non-conductive lubricant material is embedded in the contact surface of the base member.

11. An incandescent electric lamp comprising a bulb with an electrically conductive cylindrical base member attached thereto; said base member having an electrical contact surface with male threads disposed thereon for engaging with female threads disposed in a socket of a source of electric energy for said light, said threaded contact surface being provided with a layer of an electrically non-conductive material to facilitate removable engagement of said base number with said socket.

12. A compact fluorescent lamp comprising a bulb with an electrically conductive cylindrical base member attached thereto; said base member having an electrical contact surface with male threads disposed thereon for engaging with female threads disposed in a socket of a source of electric energy for said light, said threaded contact surface being provided with a layer of an electrically non-conductive material to facilitate removable engagement of said base number with said socket.

13. A socket comprising:
a threaded conductive sleeve for receiving an associated lamp having a threaded base, wherein the socket includes an electrically conductive contact surface for engaging the associated lamp, wherein the electrically conductive contact surface includes an outer layer of electrically non-conductive lubricant material for facilitating removable engagement of said associated lamp with the threaded conductive sleeve.

14. The socket of claim 13 wherein the threaded conductive sleeve is a cylinder and said contact surface are female threads disposed thereon for engaging with male threads disposed in the associated lamp.

15. The socket of claim 13, wherein the non-conductive lubricant material is a solid lubricant.

16. The socket of claim 13, wherein the non-conductive lubricant material is a liquid lubricant.

17. The socket of claim 16, wherein the non-conductive lubricant material is at least one selected from the group consisting of WD-40 aerosol spray, petroleum jelly, motor oil, canola oil, silicone, dri-film lubricant, Teflon silicone lubricant or aerosol silicones.

18. The socket of claim 13, wherein the non-conductive lubricant material is embedded in the contact surface of the base member.

19. The socket of claim 13, wherein the non-conductive lubricant material includes a plurality of microspheres.

20. A method of facilitating placement and removal of a base of an electric light bulb from a socket for providing electric energy to said light bulb which comprises applying an electrically non-conductive lubricant material to the portion of said base which contacts said socket prior to inserting said base into said socket.

21. The method of claim 20, wherein the non-conductive lubricant material is applied as a solid lubricant.

22. The method of claim 20, wherein the non-conductive lubricant material is applied as a liquid lubricant.

23. The method of claim 20, wherein said non-conductive lubricant material is applied as an aerosol spray.

24. The method of claim 20, wherein said non-conductive lubricant material is applied to the base of the light bulb using a towelette.

25. The method of claim 20, wherein the non-conductive lubricant material is applied as a liquid lubricant.

26. The method of claim 20, wherein the non-conductive lubricant material includes a plurality of microspheres.

27. A method of facilitating placement and removal of a base of an electric light bulb from a socket for providing electric energy to the light bulb which comprises applying an electrically non-conductive lubricant material to a portion of the socket base that contacts the base of the light bulb prior to inserting said base into said socket.

28. The method of claim 27, wherein the non-conductive lubricant material is applied as a solid lubricant.

29. The method of claim 27, wherein the non-conductive lubricant material is applied as a liquid lubricant.

30. The method of claim 27, wherein said non-conductive lubricant material is applied as an aerosol spray.

31. The method of claim 27, wherein said non-conductive lubricant material is applied to the socket using a towelette.

32. The method of claim 27, wherein the non-conductive lubricant material is applied to the socket in a paste form.

33. The method of claim 27, wherein the non-conductive lubricant material includes a plurality of microspheres.
